(19) United States
(12) Patent Application Publication
(10) Pub. No.: US 2006/0245889 A1
(43) Pub. Date: Nov. 2, 2006

(54) Device and method for manipulating rolled materials

(76) Inventor: Ron Reichert, Pleasant Grove, UT (US)

Correspondence Address: THORPE NORTH & WESTERN, LLP., 8180 SOUTH 700 EAST, SUITE 200, SANDY, UT, 84070, US

(21) Appl. No.: 11/087,189

(22) Filed: Mar. 22, 2005

(51) Int. Cl. B66F 9/18

(52) U.S. Cl. 414/607

(57) ABSTRACT

A device for lifting and manipulating a roll of material includes a wheeled frame, having a pair of forwardly extending, spaced-apart legs, configured to straddle a palette. A cross bar is disposed atop and extends between the legs, and has an elevation sufficient to pass over the palette. A single column is laterally moveably disposed atop the cross bar, and a roll lifting and manipulating mechanism is attached to the column. The roll lifting and manipulating mechanism is configured to engage a vertically oriented hollow cylindrical core of the roll of material, lift the roll, and rotate the roll to a position with the core substantially horizontal.

### BACKGROUND

1. Field of the Invention

The present invention relates generally to material handling. More particularly, the present invention relates to a device and method for lifting, positioning and transporting rolls of material wrapped about a hollow cylindrical core.

2. Related Art

Many manufacturing processes require the use of various materials such as packaging, film, plastic, paper, or foil which are normally supplied to machinery in roll form. Modern machinery, which has become larger and faster, requires larger rolls containing more material in order to reduce the need for shut down or production delays during roll changes. These larger rolls, up to 24 inches or more in width, and 40 inches in diameter, can weigh over 800 pounds. At the same time, a large percentage of rolls still range from 50 to 200 pounds. Safety requirements for repetitive lifts, such as those imposed by the Occupational Safety and Health Administration (OSHA), recommend the use of mechanical assist devices for such rolls, even where they could be manually lifted. Smaller rolls are commonly placed side-by-side on a palette, requiring a lifting device to be capable of positioning over nearly the entire surface of the palette.

The preferred method of roll shipment is on a pallet, or other similar support or container, with the roll core in the vertical position (core vertical). Shipment of the roll in an upright position (core horizontal) requires blocking or chocking the rolls to prevent instability, and often results in damage to the material or machinery upon use, due to imbalance created during transport or storage.

Nearly all machinery requires the roll to be in the core horizontal position during use. Because most rolls too heavy for repetitive human manipulation, a mechanical method of manipulating rolls from the preferred shipping position (core vertical), to the use position (core horizontal), and transporting them from the storage or shipping site to the machinery is needed. This mechanical method, in the past, has generally been by the use of general purpose machines such as fork lifts or palette jacks.

After the rolled material has been removed from storage or shipping and transported to the site of use it remains in the core-vertical orientation. Positioning the roll on a mandrel for utilization of machinery has often been accomplished in a make-shift way. While fork lifts and other individual roll-delivery devices have the means to manipulate an object vertically, they often do not have the capability of moving an object in other directions. Use of vertical lift-only equipment may result in attempts to manually manipulate the rolls from the core vertical position to the core horizontal position, often resulting in damage to the roll stock and even injury to technicians.

Another drawback with the use of general purpose machines, such as fork lifts is that they are relatively expensive. More flexible, safer, and cleaner general purpose designs are increasingly expensive, and this kind of expense is not warranted when a commercial application only requires the efficient manipulation and transport of heavy rolled materials.

To address some of the disadvantages mentioned above, smaller special use machines have been developed solely for lifting and manipulating rolled materials. Unfortunately, while many of these special use machines do accomplish their intended purpose, they tend to be bulky, awkward, and expensive. These machines also allow the palette to be approached, but cannot effectively maneuver over the surface of the palette. Some of these machines are difficult to manipulate, and tend to block the view of the operator. Additionally, it can be difficult for a potential purchaser of such a machine to justify a large expense for a machine that has only one use.

### SUMMARY

It has been recognized that it would be advantageous to develop a rolled material manipulation machine that is relatively small, lightweight, and easy to maneuver, and which can be maneuvered over a support palette.

It has also been recognized that it would be advantageous to develop a rolled material manipulation machine that provides better visibility for an operator.

It has also been recognized that it would be advantageous to develop a rolled material manipulation machine that is mechanically simple.

In accordance with one aspect thereof, the invention provides a device for lifting and manipulating a roll of material, including a wheeled frame, including a pair of forwardly extending, spaced-apart legs, configured to straddle a palette. A cross bar is disposed atop and extends between the legs, and has an elevation sufficient to pass over the palette. A single column is laterally moveably disposed atop the cross bar, and a roll lifting and manipulating mechanism is attached to the column. The roll lifting and manipulating mechanism is configured to engage a vertically oriented hollow cylindrical core of the roll of material, lift the roll, and rotate the roll to a position with the core substantially horizontal.

In accordance with another aspect thereof, the invention provides a method for lifting and manipulating a roll of material. The method includes the steps of: positioning a moveable frame, having an elevated transverse support configured to pass above a palette, in straddling relationship with a palette, and manipulating the frame so as to forwardly align a roll-engaging device, attached to the frame, with a substantially vertical hollow core of a roll of material supported on the palette; laterally sliding a single vertical column, moveably disposed upon the transverse support, so as to laterally align the roll-engaging device with the core; engaging the roll-engaging device with the core; lifting the roll-engaging device upon the vertical column so as to lift the roll above the palette; and rotating the roll-engaging device to position the core substantially horizontally.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, and wherein:

FIG. 1 is a perspective view of one embodiment of a device for manipulating rolled materials in accordance with the present invention;

FIG. 2 is top view of the device of FIG. 1;

FIG. 3 is a right side view of the device of FIG. 1, showing the device approaching a roll of material on a pallet, the roll being in the core-vertical position;

FIG. 4 is a right side view of the device of FIG. 1, with the lifting arm lowered and the mandrel inserted into the roll of material;

FIG. 5 is a right side view of the device of FIG. 1, showing the lifting arm lifted with the roll held fast upon the mandrel;

FIG. 6 is a left side view of the device of FIG. 1, showing the roll of material held on the mandrel and rotated to the core-horizontal position;

FIG. 7 is a detail perspective view of the lateral translation mechanism of the device of FIG. 1;

FIG. 8 is a detail perspective view of the lifting arm and hydraulic pump mechanism; and

FIG. 9 is a perspective view of a prior art rolled material manipulation device.

### DETAILED DESCRIPTION

Reference will now be made to the exemplary embodiments illustrated in the drawings, and specific language will be used herein to describe the same. It will nevertheless be understood that no limitation of the scope of the invention is thereby intended.

As noted above, roll materials are frequently shipped and stored on a palette with the roll core in the vertical position. However, use of the roll usually requires lifting and rotating the roll to a position with the core horizontal. Consequently, a variety of machines and methods have been developed for lifting and manipulating rolled materials. Some of these comprise modifications to general purpose equipment, such as a fork lift. Other specialty devices have also been developed specifically for lifting and manipulating rolled materials.

One prior roll manipulating device is shown in FIG. 9. The device includes a base 14 with a main support member 16 and legs 18 extending therefrom to form a U-shaped configuration which can envelope a pallet 20 on three sides. Upstanding from the base is a vertical support frame including two vertical support members 22, interconnected by a superior cross brace 24. Disposed on the underside of the base are wheels, including non-swiveling wheels 68, which are attached to the front of the base legs, and one or more swiveling wheels 70 are attached at or near the main support member 16.

Movably attached to the vertical support members 22 is a horizontal support assembly, including a rear lift plate 30 and front lift plate 32, with associated struts and bearings. The bearings move in the inwardly facing channels of the vertical support members, so as to provide a vertical path of travel for the horizontal support. Also included in the horizontal support are horizontal channels 38 which provide a substantially horizontal path of travel for the front lift plate. A lift post 44 extends from the front lift plate, and an expandable mandrel 52 is pivotally attached to the lift post via a pivot assembly 50. Lateral adjustment of the position of the lift post 44 can be accomplished by means of a horizontal hydraulic cylinder 74 associated with the horizontal lift assembly. This cylinder is attached between lift plates 30 and 32, and causes the plates and their respective structure to move in relation to each other.

The mandrel 52 is configured to insert into the vertically oriented core 12 of the roll 10, and expand to grip the roll, to allow the roll to be lifted by the horizontal lift assembly, which is accomplished by a hydraulic lift cylinder 72 attached at its base to the main support member 16 and at its top to the horizontal lift assembly. The mandrel has an approximately 90° range of travel, from a substantially vertical position (shown in FIG. 9) to a substantially horizontal position (not shown). The mandrel is rotated between these positions by a hydraulic cylinder 54, which is connected to an arm 48 extending below the pivot assembly.

The various hydraulic cylinders required to operate the device of FIG. 9 are actuated by a master pump operated by a battery driven motor. The device is configured such that the batteries, motor, and pump are disposed upon a rear section of the base 14, between the side gussets 26. With all of these components and features, the machine of FIG. 9 tends to be bulky, awkward, and expensive. The large size and weight of the machine makes it difficult to manipulate, and tends to block the view of the operator. Additionally, this specialty machine is relatively expensive. A potential purchaser may have difficulty justifying such an expense for a machine that has only one use.

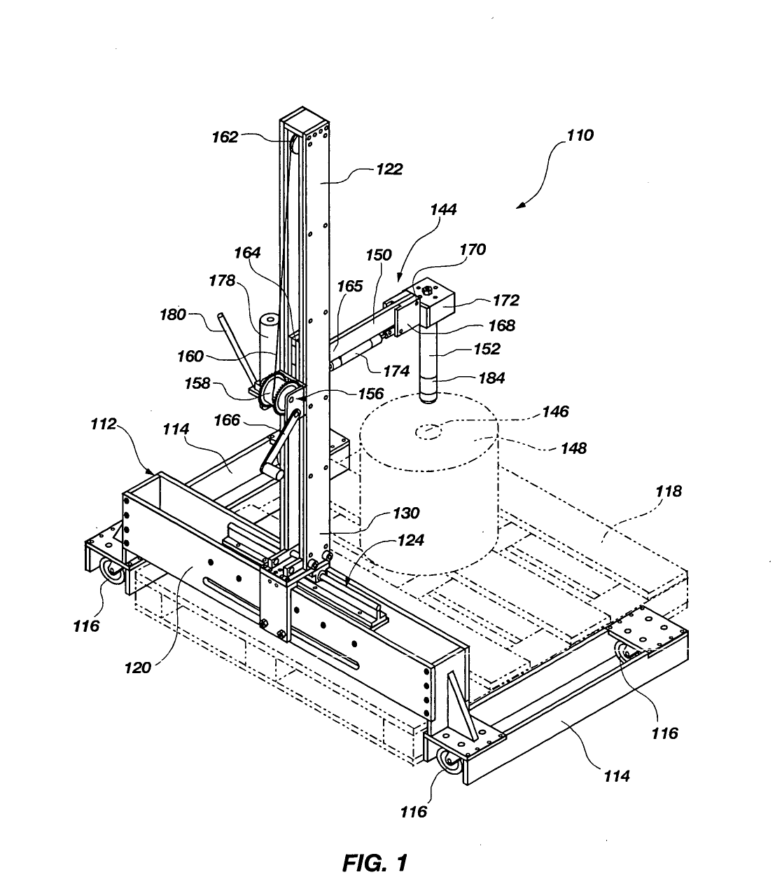

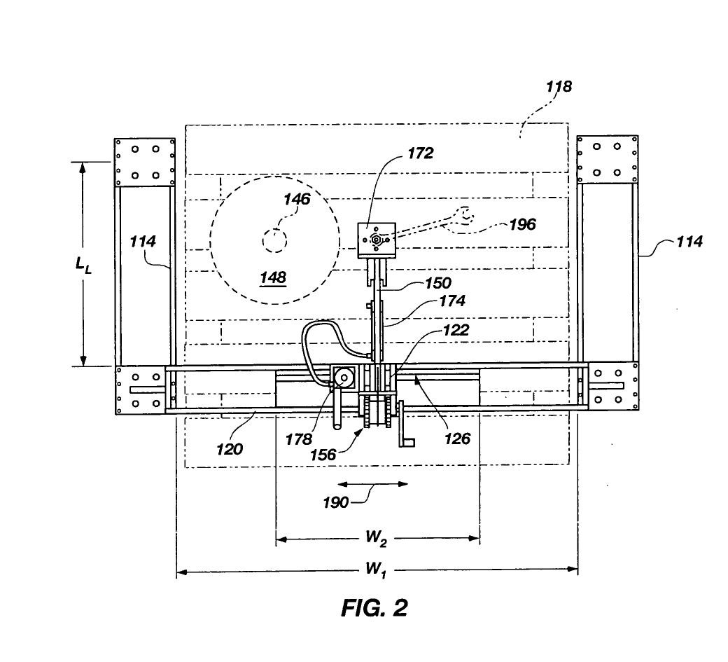

Advantageously, the inventor has developed a new device 110 for lifting and manipulating rolls of material, various views of one embodiment of which are shown in FIGS. 1-8. Referring to the perspective view of FIG. 1 and the top view of FIG. 2, the device generally comprises a moveable frame 112, having a pair of forwardly extending, spaced-apart legs 114. The legs include heavy duty casters 116 that allow the device to be rolled to any desired position and in any desired orientation upon a floor or other firm support surface. The legs are substantially parallel to each other, and are spaced at a distance W₁ suitable for straddling a palette 118 or other shipping support that is used for rolled materials. Disposed atop the rear of the support legs is a cross bar or transverse support 120 that is substantially perpendicular to the legs and extends between them. Advantageously, the cross bar or transverse support is disposed at an elevation H that is sufficient to allow it to pass over or above the palette.

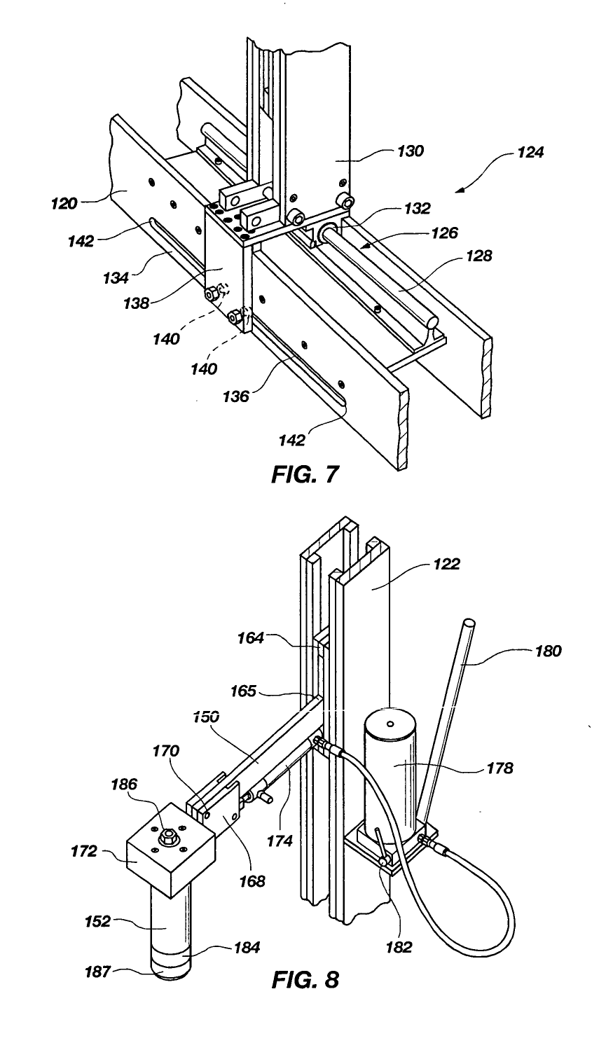

Disposed atop the cross bar 120 is a single upright column 122. The column is laterally moveable, being supported upon a lateral shifting mechanism 124 disposed atop the cross bar. A detail perspective view of the lateral shifting mechanism is shown in FIG. 7. In the embodiment shown in the figures, the lateral shifting mechanism comprises an elongate sliding bearing 126, disposed along the cross bar. The elongate bearing includes a cylindrical hardened steel bar 128, onto which the lower portion 130 of the column is attached via a sliding bushing 132.

The lateral shifting mechanism 124 also includes structure for limiting an extent of lateral travel of the column 122 upon the sliding bearing 126. In the embodiment shown in the figures, the lower back side 134 of the cross bar 120 includes an elongate slot 136 that is aligned with the elongate bearing 126, and has a length that is slightly less than the length of the elongate bearing (W₂ in FIG. 2). Descending from the base of the column 122 is a back plate 138. A pair of rollers 140 are attached to the back plate, and extend into the elongate slot. The length and position of the slot is such that, when the column slides along the bearing and nears the end of the steel bar 128, one of the rollers will contact an end 142 of the elongate slot, and prevent any further sliding. This prevents the bushing 132 at the base of the column from sliding past the end of the steel bar.

Referring again to FIG. 2, the elongate bearing 126 is approximately centered along the cross bar 120, and is sized to provide sufficient lateral translation of the column 122 to allow the roll manipulating device 110 to pick up rolls that are at various locations on a support palette. For example, where the legs 114 are spaced a distance W₁ of 52 inches so as to allow them to straddle a palette 118 of up to 48 inches wide, the elongate bearing 126 can have a length W₂ of about 36 inches to provide the column 122 with a total range of lateral travel of about 32 inches. This range of lateral travel allows the column to be moved from side to side to pick up rolls at nearly any position on the palette. The size and configuration of the lateral shifting mechanism as described is only one example of a suitable mechanism. It will be apparent that mechanisms of different configurations and sizes can be incorporated into the present invention.

Slidably connected to the column 122 is a roll lifting and manipulating mechanism 144 that is configured to engage the vertically oriented hollow cylindrical core 146 of the roll of material 148, lift the roll, and rotate the roll to a position with the core substantially horizontal. Various views of this mechanism are provided in FIGS. 1, 2, and 8. The roll lifting and manipulating mechanism can be configured in a variety of ways. In the embodiment shown in the figures, the roll lifting and manipulating mechanism includes a lifting arm 150, forwardly extending from the column, and a mandrel 152, rotatably connected to a distal end of the arm. The column includes a lifting mechanism comprising a winch device 156, attached to the column, and including a winding cylinder 158 with an internal reduction gear and ratchet mechanism (not shown), a cable 160, and a pulley 162 disposed in the top of the column. The cable is attached to a sliding bearing or trolley 164 disposed in a track in the column, to which the base 165 of the lifting arm is attached. In the embodiment shown in the figures, the winch includes a crank 166 with a handle, for allowing manual operation of the winch. However, it will be apparent that a power drive for the winch could also be provided. Additionally, a power lead-screw (not shown) can also be used to raise and lower the lifting mechanism.

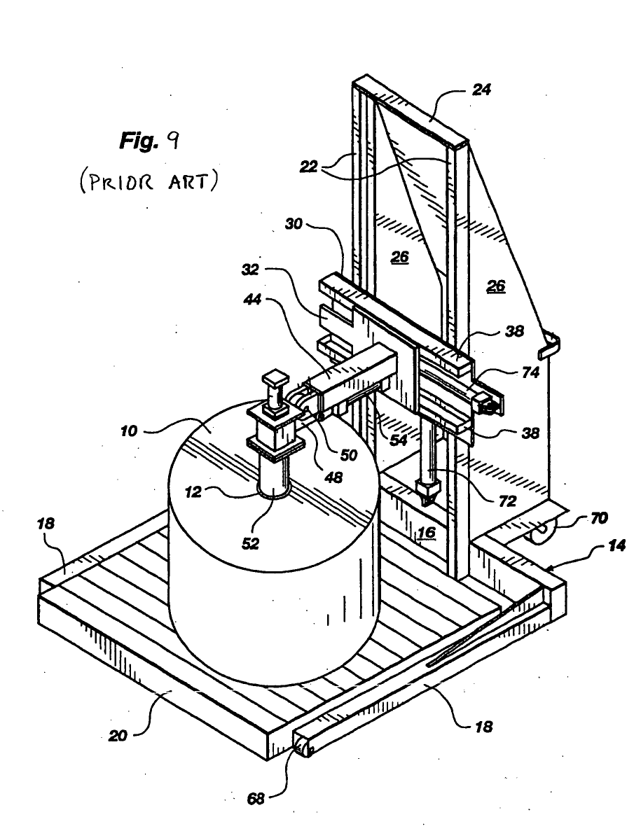

The mandrel 152 is pivotal between a substantially downwardly oriented position (shown in, e.g., FIGS. 1, 3, and 8), and a substantially horizontal position forwardly extending from the arm 150 (shown in FIG. 6). As shown most clearly in FIGS. 6 and 8, the mechanism for rotating the mandrel comprises a pivoting link 168, which pivots about a pivot point 170 and interconnects the mandrel head piece 172 to the distal end of the arm. An actuator 174 is disposed substantially below the lifting arm, and is attached between the base of the lifting arm and the pivoting link. The actuator is attached to the pivoting link at a point below the pivot point. When the actuator is retracted, the mandrel rests in a substantially downwardly oriented position. However, when the actuator is extended, the extensible arm of the actuator rotates the pivoting link 168 about the pivot point 170, so as to rotate the head piece 172 and the mandrel 152 to a substantially horizontal position, as shown in FIG. 6.

Viewing FIGS. 1, 2, 6, and 8, the actuator 174 is a hydraulic slave cylinder operably interconnected to a hydraulic master cylinder 178. Associated with the master cylinder is a pump mechanism having a pump lever 180, which is configured to allow a user to manually increase the hydraulic pressure. When the pressure is increased, the slave cylinder extends and rotates the mandrel 152, as described above. The hydraulic system also includes a release valve 182, with which a user can release the hydraulic pressure, allowing the mandrel to drop under its own weight to the downwardly oriented position.

The mandrel 152 is configured to insert downwardly into and engage the hollow cylindrical core 146 of a roll of material 148. A variety of types of mandrels configured to mechanically engage the core of a roll can be used. In the embodiment shown in the figures, the mandrel is an expanding mandrel, having a resilient rubber bushing 184 that is configured to expand to contact the inside of the hollow tubular core of the roll, as depicted in FIG. 4. As shown in FIGS. 2, 4, and 8, the head piece 172 of the mandrel includes an adjustment nut 186, which, when turned in one direction, draws a distal end piece 187 of the mandrel toward the head end of the mandrel, thereby longitudinally squeezing the rubber bushing, and causing it to laterally expand within the hollow cylindrical core of the roll. Friction between the rubber bushing and the core provides sufficient strength to hold even very heavy rolls upon the mandrel. Other devices for expanding the bushing, including power-actuated devices, can also be used. For example, a power lead screw (not shown) could be provided for drawing the end piece of the mandrel toward the head piece.

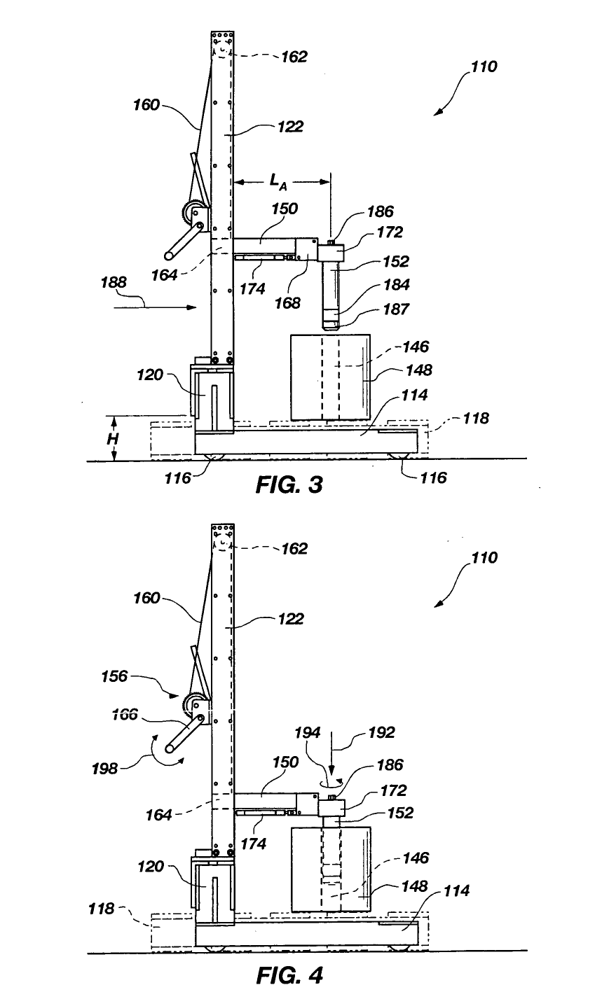

The combination of the elevated cross bar 120 and the lateral shifting mechanism 124 for the single column 122 provide a variety of advantages in the present invention. Because the cross bar is elevated, it can pass over or above the top of a palette 118 (or other support) to reach rolls of material 148, as depicted in FIGS. 1 and 3. This allows the lifting arm 150 to be shorter and yet still reach any desired region of a support palette. For example, considering the top view of FIG. 2, where a roll is disposed near a far edge of a palette, it is necessary for the mandrel to be positioned above the hollow core 146 of the roll to be able to lift the roll. With some prior devices, such as that shown in FIG. 9, because the transverse structure of the roll lifting device does not clear the palette, the lifting arm must extend the entire distance to near the far side of the palette to allow a user to align the mandrel (in the forward/backward direction) with the roll. This requires the lifting arm and forward legs to be longer and stronger in order to bear the large cantilever forces imposed by the weight of the roll.

Advantageously, because the cross bar 120 of the present device can pass over the palette 118, the length L_{A} of the lifting arm 150 need not be so long, and the arm can therefore be a smaller, lighter structure. Additionally, because the lifting arm is shorter, the support legs 114 can also be shorter because the center of mass of the device when loaded will be closer to the rear. Specifically, the length L_{L} of the support legs can be substantially less than the lateral spacing W₁ between the legs. In one operative example, where the length L_{A} of the lifting arm is 12 inches, and the lateral spacing W₁ between the legs is 52 inches, the legs can have a length L_{L} of 24 inches.

Additionally, the lateral shifting capability of the upright column 122 allows the distal end of the lifting arm 150 and the mandrel 152 to be positioned over rolls 148 positioned near the sides of a support palette 118. Use of the device is thus very simple, and is illustrated in FIGS. 3-6. To lift and manipulate a roll of material, a user first positions the moveable frame 112 with the legs 114 straddling a palette or other support for rolled material, as depicted in FIGS. 2 and 3. With the elevated transverse support 120 able to pass above the palette, the user can easily manipulate the frame in the forward/backward direction, represented by arrow 188, so as to forwardly align the mandrel with the vertical core 146 of the roll of material. The user then laterally aligns the mandrel with the core by laterally sliding the vertical column in the direction of arrow 190 in FIG. 2. Advantageously, the user can laterally move the vertical column simply by manually sliding the column along the elongate sliding bearing 126.

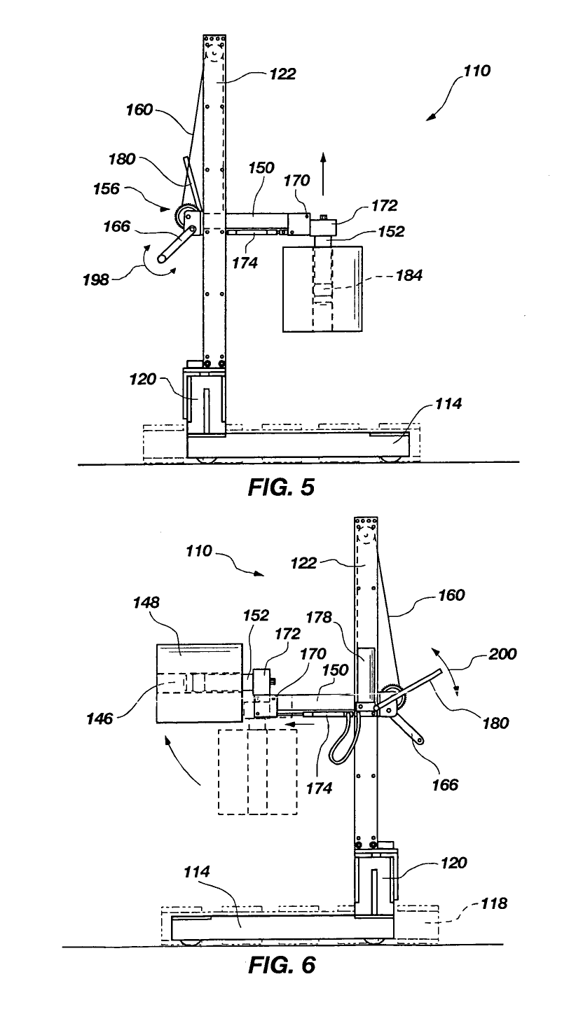

Once aligned with the vertical core 146, the user lowers the lifting arm 150 so as to insert the mandrel 152 down into the core, in the direction of arrow 192, and then mechanically engages the mandrel with the core, as shown in FIG. 4. In the embodiment shown in the figures and described above, engagement of the mandrel involves rotating the adjustment nut 186 on the head piece 172 of the mandrel, so as to laterally expand the rubber bushing 184 to frictionally grip the core. Rotation of the adjustment nut, represented by arrow 194 in FIG. 4, can be accomplished using a wrench (196 in FIG. 2) or any other suitable tool. Once the roll is properly engaged with the mandrel, the user can lift the roll to any desired height on the column by turning the crank 166, as represented by arrow 198, to raise the roll-engaging device 144 via the winch mechanism 156, so as to lift the roll 148 above the palette 118, as shown in FIG. 5. Once the roll is lifted, the user then extends the actuator 174 by working the pump lever 180 of the hydraulic system, as represented by arrow 200, so as to rotate the roll-engaging device to position the core substantially horizontally, as shown in FIG. 6.

Once the core 146 is horizontal, the user can move the roll manipulating device 110—with the roll attached—to a location adjacent to a point of use for the rolled material, such as to a machine (not shown) having a horizontal spool, shaft, or axle configured to receive the roll. It is usually desirable to transport the roll upon the machine with the core in the horizontal position, so that the roll is not as likely to fall off if the mandrel were to loosen. Additionally, for maximum stability and safety, the lifting arm 150 can be kept at a relatively low elevation while moving the device with a roll attached, so that the center of gravity of the device is maintained relatively low. If needed, the user can lower the arm 150 after rotating the roll to the horizontal position.

Upon arrival at a point of use for the roll 148, the user aligns the core 146 of the roll with the spool or axle (not shown) of the receiving machine by any needed combination of rolling the frame 112 upon the floor, adjusting the lateral shifting mechanism 124, and adjusting the height of the roll with the winch mechanism 156. Because the mandrel 152 does not ordinarily extend entirely through the core of the roll, a portion of the inside of the core at its far end (referring to the horizontal orientation) is typically unobstructed, allowing a portion of the end of the core to be slid onto a receiving spool or shaft while the roll remains on the mandrel. When the core is properly aligned with the spool or axle of the receiving machine, the user then releases the grip of the mandrel by rotating the mandrel tightening mechanism (e.g. the adjustment nut 186) in a direction opposite to the tightening direction. Once the grip of the mandrel is released, the roll can be easily slid horizontally from the mandrel and onto the receiving shaft, and secured in place. To return the mandrel to the vertical position, the user simply opens the release valve 182 of the hydraulic system, allowing the mandrel to rotate downward under its own weight, and the roll manipulating device is then ready for use elsewhere.

The invention thus provides a smaller, lighter-weight, and less expensive device for lifting and manipulating heavy rolls of material. Its single column design provides better visibility for the operator, and the small size of the machine makes it easier to maneuver. Its elevated transverse member allows the device to have shorter legs and a shorter lifting arm, yet still reach rolls on far edges of support palettes. Additionally, its use of manually operable devices, such as the manual winch and manually powered hydraulic system, eliminate the need for heavy and expensive motors or other power sources.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A device for lifting and manipulating a roll of material, comprising:
a) a wheeled frame, including
i) a pair of forwardly extending, spaced-apart legs, configured to straddle a palette;
ii) a cross bar, disposed atop and extending between the legs, having an elevation sufficient to pass over the palette; and
iii) a single column, laterally moveably disposed atop the cross bar; and
b) a roll lifting and manipulating mechanism, attached to the column, configured to
i) engage a vertically oriented hollow cylindrical core of the roll of material;
ii) lift the roll; and
iii) rotate the roll to a position with the core substantially horizontal.

2. A device in accordance with claim 1, further comprising a lateral shifting mechanism, interconnecting the column and the cross bar, configured to allow the column to be shifted between a plurality of positions along the cross bar.

3. A device in accordance with claim 2, wherein the lateral shifting mechanism comprises:
a) an elongate sliding bearing, disposed along the cross bar; and
b) means for limiting an extent of lateral travel of the column upon the sliding bearing.

4. A device in accordance with claim 1, wherein the roll lifting and manipulating mechanism comprises:
a) an arm, forwardly extending from and vertically slidably connected to the single column; and
b) a mandrel, rotatably connected to a distal end of the arm, configured to insert into and engage the hollow cylindrical core.

5. A device in accordance with claim 4, further comprising a lifting mechanism, associated with the single column, configured to selectively lift and lower the arm along the column.

6. A device in accordance with claim 5, wherein the lifting mechanism comprises a winch device, attached to the column.

7. A device in accordance with claim 6, wherein the winch device is manually operable.

8. A device in accordance with claim 4, wherein the mandrel is pivotal between a substantially downwardly oriented position, and a substantially horizontal position forwardly extending from the arm.

9. A device in accordance with claim 4, further comprising a mechanism for rotating the mandrel.

10. A device in accordance with claim 8, wherein the mechanism for rotating the mandrel comprises:
a) a pivoting link, interconnecting the mandrel and the distal end of the arm, having a pivot point; and
b) an actuator, attached to the pivoting link at a point below the pivot point, the actuator having a first retracted position wherein the mandrel is substantially downwardly oriented, and a second extended position, wherein the mandrel is upwardly rotated to a substantially horizontal position.

11. A device in accordance with claim 10, wherein the actuator comprises a hydraulic slave cylinder, and further comprising a hydraulic master cylinder, configured to provide hydraulic pressure to the slave cylinder for extension thereof.

12. A device in accordance with claim 4, wherein the mandrel is an expanding mandrel, configured to expand within the hollow cylindrical core of the roll, so as to frictionally engage the core.

13. A device in accordance with claim 1, wherein a lateral spacing between the spaced apart support legs is greater than a length of the support legs.

14. A device for lifting and manipulating a roll of material, comprising:
a) a moveable frame, configured to straddle a palette, having
i) a transverse support configured to pass above the palette; and
ii) a single upright column laterally moveably supported upon the transverse support; and
b) means for lifting and manipulating the roll of material, said means being attached to the upright column, and configured to
i) insert substantially vertically downwardly into a hollow cylindrical core of the roll;
ii) to engage the core;
iii) to lift the roll;
iv) and to rotate the roll to a position with the core substantially horizontal.

15. A device in accordance with claim 14, wherein the means for lifting and manipulating the roll of material comprises
a) a mandrel, vertically moveably attached to the column, configured to insert downwardly into and to mechanically engage the core;
b) a lifting mechanism, configured to raise the mandrel with the roll of material thereupon; and
c) a rotating mechanism, configured to rotate the mandrel and the roll of material.

16. A device in accordance with claim 15, wherein the lifting mechanism comprises:
a) an arm, forwardly extending from the single column; and
b) a winch device, configured to selectively raise and lower the arm along the column.

17. A device in accordance with claim 15, wherein the rotating mechanism comprises:
a) a pivoting link, interconnecting the mandrel and the lifting mechanism;
b) an actuator, attached between the pivoting link and the lifting mechanism, having a first retracted position wherein the mandrel is substantially downwardly oriented, and a second extended position, wherein the pivoting link and mandrel are upwardly forwardly rotated.

18. A method for lifting and manipulating a roll of material, comprising the steps of:
a) positioning a moveable frame, having an elevated transverse support configured to pass above a palette, in straddling relationship with a palette, and manipulating the frame so as to forwardly align a roll-engaging device, attached to the frame, with a substantially vertical hollow core of a roll of material supported on the palette;
b) laterally sliding a single vertical column, moveably disposed upon the transverse support, so as to laterally align the roll-engaging device with the core;
c) engaging the roll-engaging device with the core;
d) lifting the roll-engaging device upon the vertical column so as to lift the roll above the palette; and
e) rotating the roll-engaging device to position the core substantially horizontally.

19. A method in accordance with claim 18, wherein the step of lifting the roll-engaging device comprises engaging a winch mechanism interconnected between the column and the roll-engaging device, so as to raise the roll-engaging device along the column.

20. A method in accordance with claim 18, wherein the step of laterally sliding the single vertical column comprises manually sliding the column along an elongate sliding bearing disposed atop the transverse support.
